(19) United States
(12) Patent Application Publication
(10) Pub. No.: US 2013/0002693 A1
(43) Pub. Date: Jan. 3, 2013

(54) VIDEO DISPLAY APPARATUS, BUFFER MANAGEMENT METHOD AND VIDEO DISPLAY SYSTEM

(76) Inventor: Kazuya Nara, Kumagaya-shi (JP)

(21) Appl. No.: 13/397,444

(22) Filed: Feb. 15, 2012

(30) Foreign Application Priority Data
Jun. 30, 2011 (JP) 2011-146613

(51) Int. Cl. G09G 5/39

(52) U.S. Cl. 345/531

(57) ABSTRACT

One embodiment provides a video display apparatus, including: a buffer configured to receive data; a buffer controller configured to control the buffer; and a reproduction part configured to reproduce the data accumulated in the buffer, wherein, when reproduction from an arbitrary position is designated for a time during which the reproduction part reproduces the data, the buffer controller controls the buffer to accumulate data of a designated destination while continuing reproduction of the data left in the buffer.

### CROSS-REFERENCE TO RELATED APPLICATION(S)

This application claims priority from Japanese Patent Application No. 2011-146613 filed on Jun. 30, 2011, the entire contents of which are incorporated herein by reference.

### FIELD

Embodiments described herein relate generally to a video display apparatus, a buffer management method and a video display system which can reproduce streaming data.

### BACKGROUND

There have been developed reproducing apparatuses which reproduces distributed streaming data while allowing user to designate a scene at an unreproduced part as a viewing target.

JP-2008-135825-A discloses: to prepare buffer information for preferentially distributing a reproduction position of skip time information when a skip button is pushed down at an unreproduced part of distributed streaming data; to transmit the buffer information to a video distribution server through Internet; and to control a video player to reproduce a streaming video corresponding to a preferential buffer period received from the communication part through Internet.

However, JP-2008-135825-A describes such a method of analyzing preference of user to preferentially receive data indicating a specific position, and there is not described switching timing between a current video and a video of a designated destination and a buffer memory management method by any means.

### BRIEF DESCRIPTION OF DRAWINGS

A general architecture that implements the various features of the present invention will now be described with reference to the drawings. The drawings and the associated descriptions are provided to illustrate embodiments and not to limit the scope of the present invention.

FIG. 1 illustrates a system capable of reproducing streaming data according to an embodiment.

FIG. 2 illustrates a buffer management method in the streaming reproduction.

FIG. 3 illustrates a screen during reproduction of streaming data.

FIG. 4 illustrates a mode selection dialog screen.

FIG. 5 illustrates a display screen during buffering and during reproduction.

FIG. 6 illustrates a display screen during buffering.

FIG. 7 illustrates a data management method in the case where there is no buffer capacity.

FIG. 8 illustrates the case where there is reproduced data in buffer.

FIG. 9 illustrates the case where there is no reproduced data in buffer.

### DETAILED DESCRIPTION

One embodiment provides a video display apparatus, including: a buffer configured to receive data; a buffer controller configured to control the buffer; and a reproduction part configured to reproduce the data accumulated in the buffer, wherein, when reproduction from an arbitrary position is designated for a time during which the reproduction part reproduces the data, the buffer controller controls the buffer to accumulate data of a designated destination while continuing reproduction of the data left in the buffer.

Embodiments will now be described with reference to the attached drawings.

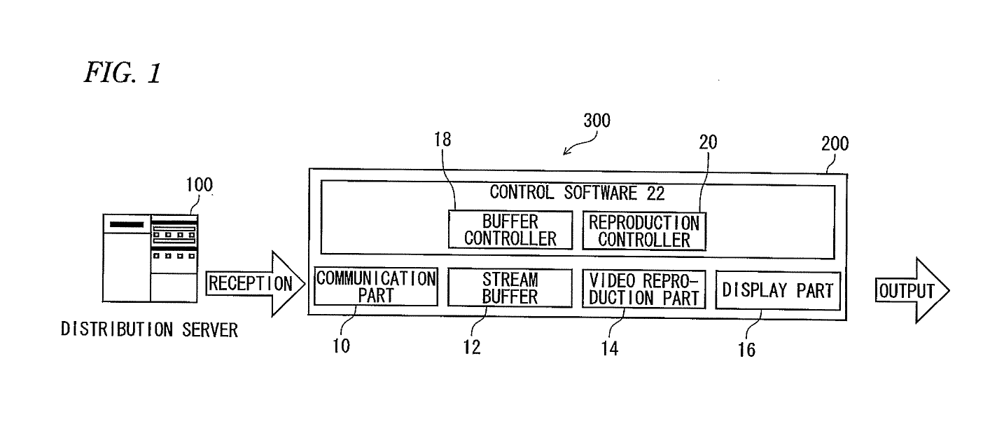

FIG. 1 illustrates a system capable of reproducing streaming data according to an embodiment. Elements, components and/or functions which will be described later may be realized by hardware, or may be realized by software using microcomputer (processor and/or CPU), etc.

A video display system 300 shown in FIG. 1 includes a streaming distribution server 100, and a video display part 200. The video display part 200 includes a communication part 10 configured to receive streaming data from the streaming distribution server 100, a stream buffer 12 configured to temporarily store streaming data, a video reproduction part 14 configured to reproduce stream, a display part 16 configured to display the stream, and a control software 22 for controlling those components. Specifically, the control software 22 includes a buffer controller 18 for controlling the stream buffer 12 and a reproduction controller 20 for controlling the video reproduction part 14.

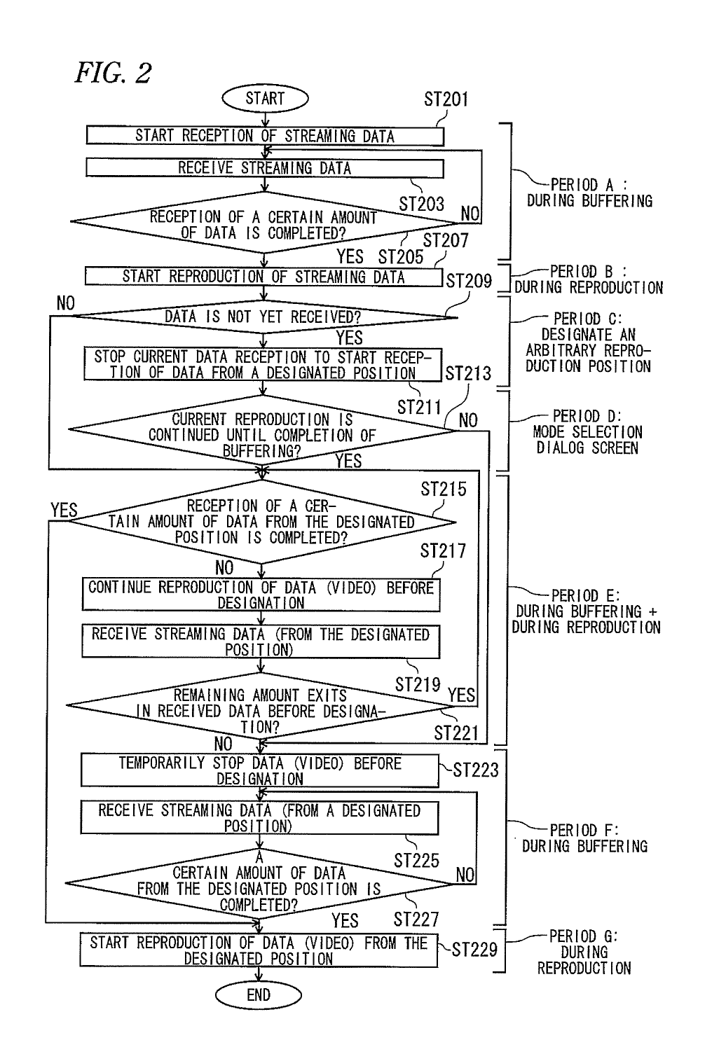

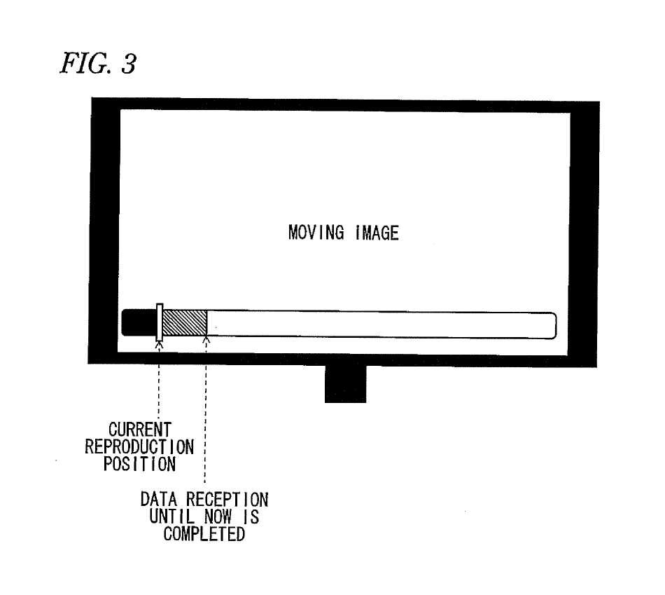

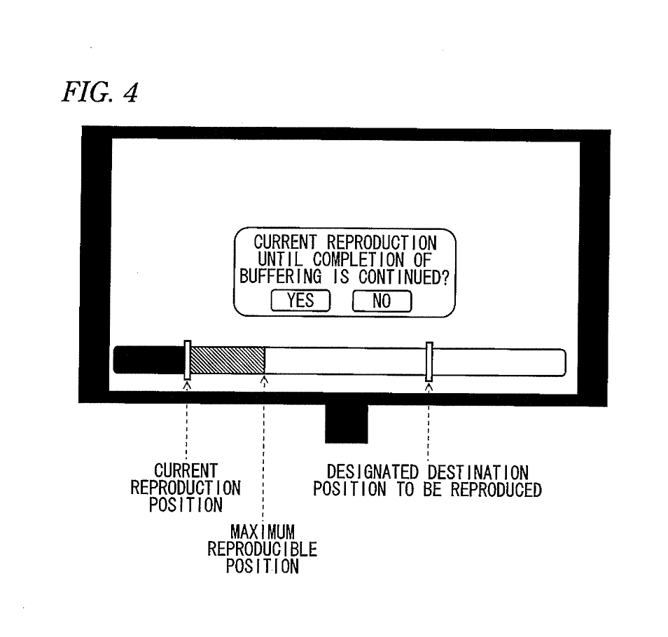

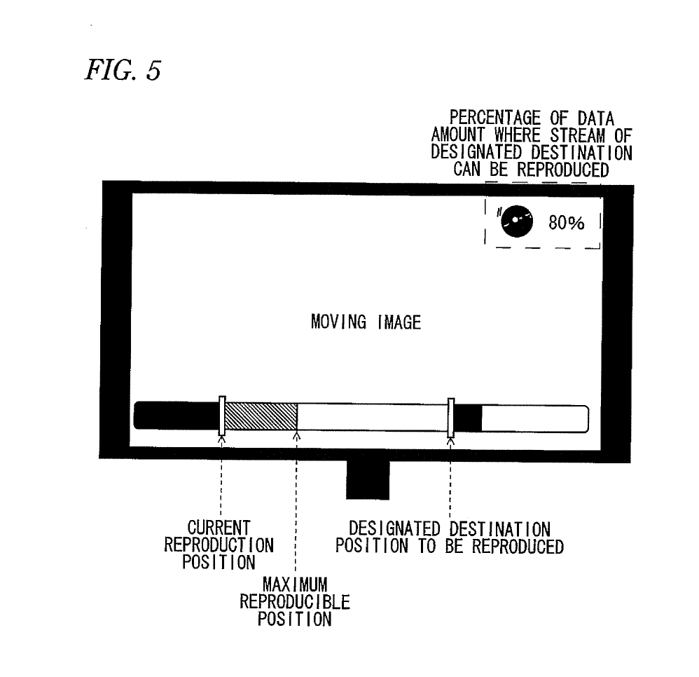

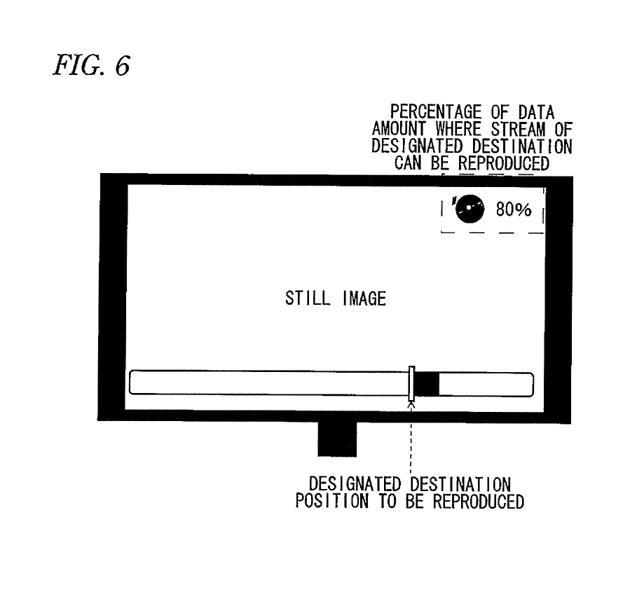

FIG. 2 illustrates a buffer management method in the streaming reproduction. FIG. 3 illustrates a screen during reproduction of streaming data, FIG. 4 illustrates a mode selection dialog screen, FIG. 5 illustrates a display screen during buffering and during reproduction, and FIG. 6 illustrates a display screen during buffering.

### <During Buffering (Period A)>

As shown in FIG. 2, when user selects contents subject to streaming distribution (step ST201), the communication part 10 receives streaming data from the streaming distribution server 100 (step ST203). The buffer controller 18 determines as to whether or not streaming data received by the communication part 10 is accumulated by a certain amount in the stream buffer 12, whereby when it is determined that the streaming data is not accumulated by the certain amount, the buffer controller 18 controls the communication part 10 to receive streaming data until the streaming data is accumulated therein (N of step ST205). For this time period, user is placed in reproduction waiting state as a buffering period. On the other hand, when streaming data is accumulated by the certain amount in the buffer 12, process step proceeds to step S207 (Y of the step S205).

### <During Reproduction (Period B)>

When the stream buffer 12 has completed reception of a certain amount of stream data, the video reproduction part 14 starts reproduction of streaming data on the basis of control by the reproduction controller 20 (step ST207). In this example, as long as there is any margin in the buffer capacity even during reproduction of stream data, the buffer controller 18 continues to receive, in advance, data subsequent thereto.

FIG. 3 shows a display screen during reproduction, and a current reproduction position and a received data amount are displayed in a manner easy to understand on the progress bar at the lower part of the screen.

### <Designation of Arbitrary Reproduction Position (Period C)>

During reproduction, user can designate reproduction from an arbitrary position. In the case where user newly designates a reproduction position, the buffer controller 18 confirms as to whether or not data of an arbitrary designated position is received by the stream buffer 12 (step ST209). If that data is not yet received in the stream buffer 12 (unreception) (Y of the step ST209), the buffer controller 18 stops reception of current data to start to receive, from data of a designated destination, data continuous thereto (step ST211). At this time, since the stream buffer 12 has not data of designated destination by any means, the video reproduction part 14 cannot seamlessly continue reproduction.

### <Mode Selection Dialog Screen (Period D)>

In view of the above, in such cases, the reproduction controller 20 displays a mode selection dialog screen as shown in FIG. 4 on the screen, thus permitting user to select as to whether or not he waits that data of a designated position is accumulated while continuously looking at contents being reproduced, or he waits that data of the designated position is accumulated without continuing reproduction any longer (step ST213). In the case of the of the dialog screen shown in FIG. 4, whether or not reproduction performed until now is continued during buffering of a designated position can be selected in the form of “Yes” or “No”. When user selects “Yes” in the mode selection dialog screen (Y of step ST213), reproduction performed until now is continued while performing data reception at the designated position. On the other hand, when user selects “No” in the dialog screen (N of the step ST213), i.e., user waits that data of a designated position is accumulated without continuing reproduction of contents being reproduced. Thus, process step proceeds to step ST223. In this example, in the case where the reproduction controller 20 displays dialog screen, moving image being reproduced is temporarily stopped to display the stopped or stationary part as a still image. Alternatively, reproduced data which have been reproduced until now may be utilized as a still image.

In the case where data at an arbitrary position designated by user is already received in the stream buffer 12 in the step ST209 (N of step ST209), process step proceeds to step ST215.

### <During Buffering+During Reproduction (Period E)>

In the step ST215, the buffer controller 18 determines as to whether or not data at a designated position is above a certain amount (step ST215). If the buffer controller 18 determines that data at a designated position is above the certain amount (Y of the step ST215), the reproduction controller 20 completes reproduction until now to automatically perform switching to reproduction from a designated position (step ST229). It is to be noted that since the communication apparatus 10 starts data reception from the designated position, there is no possibility that data before designation may be increased in such a manner that it is above data already received before an arbitrary position is designated.

In the case where the buffer controller 18 determines that data of the designated position is not above the certain amount (N of the step ST215), the reproduction controller 20 controls the video reproduction part 14 to continue reproduction of data before designation (step ST217). Further, the buffer controller 18 controls the stream buffer 12 to receive streaming data from the designated position (step ST219). It is to be noted that if a position designated by user is a position already received by the buffer, streaming data may be received from a position at which that data has been received without receiving streaming data from the designated position.

The buffer controller 18 grasps, at all times, capacity of the stream buffer 12 to check as to whether or not there is any remaining amount in received data before designation, whereby when there is any remaining amount (Y of step ST221), process step returns to the step ST215 to repeat such processing until data at the designated position is above the certain amount. In the case where there is no remaining amount in received data before designation (N of the step ST221), i.e., in the case where already received data have been all reproduced before data from a designated position is accumulated by the certain amount, since there is no data to be continuously reproduced from that time point, process step enters processing sequence (step ST223) similar to the case where “No” is selected in the mode selection dialog.

As shown in FIG. 5, in the display screen of period E (during buffering+during reproduction), a current reproduction position, a maximum reproducible position (position at which data reception has been completed before position designation), a position of the designated destination to be reproduced, and data reception amount from a position of designated destination are displayed on the progress bar at the lower part of the image (moving image), and a percentage until data amount where stream of a designated destination to be reproduced is permitted to be reproduced is displayed at the right and upper part of the image. When this value becomes equal to 100%, reproduction of the designated destination stream is started.

### <During Buffering (Period F)>

The buffer controller 18 temporarily stops data (contents) which have been reproduced until now to perform data reception from a designated position in the state of still image (steps ST223 and ST225). As such still image, data at the moment of being temporarily stopped, and/or data already reproduced may be utilized. The buffer controller 18 extracts data from the stream buffer 12 to be displayed as the still image.

After the buffer controller 18 has performed data reception from a designated position, it determines as to whether or not data at a designated position is above a certain amount (step ST227). In the case where the buffer controller 18 has determined that the data at the designated position is not above the certain amount (N of the step ST227), it receives streaming data until the data at the designated position is above the certain amount.

As shown in FIG. 6, in the display screen of the period F (during buffering), a position of a designated destination to be reproduced and a data reception amount from the designated position are displayed on the progress bar at the lower part of the image (still image), and a percentage up to a data amount where stream of the designated destination to be reproduced can be reproduced is displayed on the right and upper part of the image. When such value becomes equal to 100%, reproduction of stream of the designated destination is started.

### <During Reproduction (Period G)>

In the case where the buffer controller 18 has determined that data at a designated position is above the predetermined amount (Y of step ST227), the reproduction controller 20 automatically performs switching to reproduction from the designated position (step ST229).

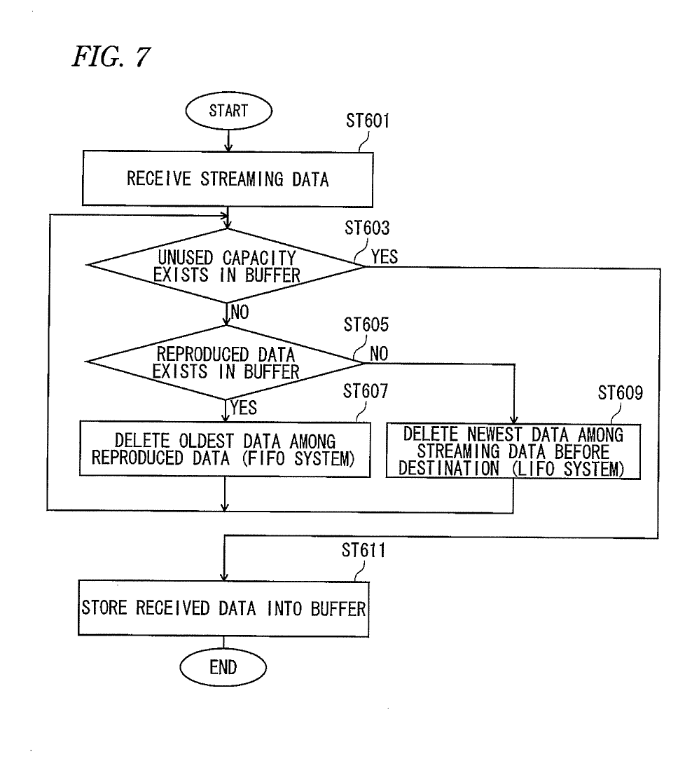

The data management method in the case where there is no buffer capacity will now be described with reference to FIG. 7. FIG. 7 illustrates the data management method in the case where there is no unused capacity in the stream buffer 12 in receiving streaming data of designated destination while continuing reproduction.

The buffer controller 18 receives streaming data of a designated destination while reproducing data before designation (step ST601). The buffer controller 18 checks as to whether or not there is any unused capacity in the stream buffer 12. Further, in the case where the buffer controller 18 has determined that there is any unused buffer capacity (Y of step ST603), it controls the buffer 12 to write data into a free space without deleting streaming data which has been received through the communication part 10 (step ST611).

In the case where the buffer controller 18 has determined that there is no unused capacity (N of step ST603), it further checks as to whether or not reproduced data is yet held in the buffer 12. Ordinarily, the buffer 12 holds reproduced data by a certain amount as a data for backup. If there is reproduced data in the buffer 12 (Y of step ST605), the buffer controller 18 preferentially deletes the reproduced data to prepare free spaces (step ST607).

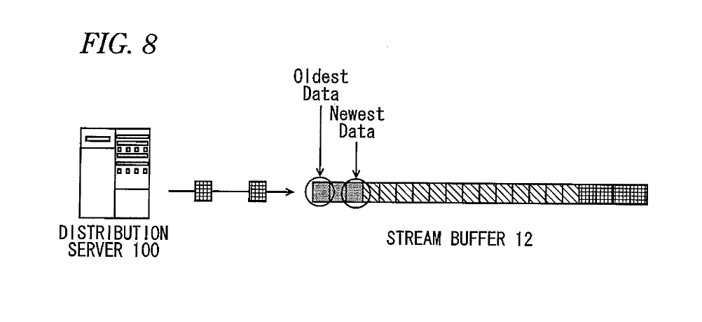

FIG. 8 illustrates the state where streaming data of designated destination are distributed from the distribution server 100 so that the stream buffer 12 is placed in full state. In this example, the stream buffer 12 is conceptually divided into plural segments, wherein three segments from the left side indicate reproduced data, the fourth to the 16-th segments indicate received data before designation, and the 17-th to the last (20-th) segments indicate received data of designated destination. When the buffer controller 18 deletes reproduced data, it performs deletion from the oldest data. Namely, there is employed a scheme to preferentially perform deletion from the Oldest Data on the leftmost side of FIG. 8 to prepare unused capacity (FIFO system).

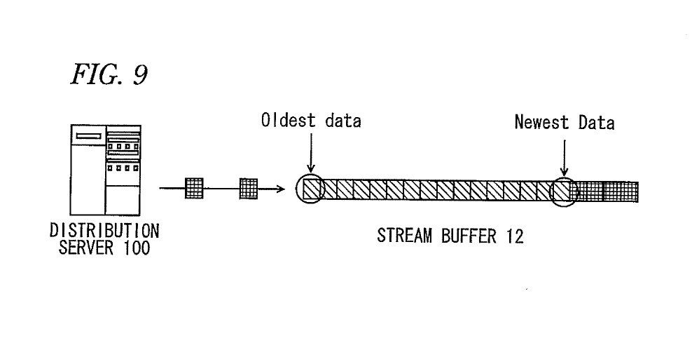

In the case where the buffer controller 18 to determines that there is no reproduced data in the buffer 12 (N of step 605), it deletes received data before designation of the reproduction position to prepare free spaces (step ST609). FIG. 9 illustrates the state where streaming data of a designated destination are distributed from the distribution server 100 similarly to FIG. 8 so that the stream buffer 12 is placed in full state. In this case, the point different from FIG. 8 is that no reproduced data is held in the buffer 12. In the buffer 12 of FIG. 9, the segments from the left side up to the 16-th segment indicate received data before designation, and the 17-th to the last (20-th) segments indicate received data of a designated destination. When the buffer controller 18 deletes received data before designation, it performs deletion from the Newest Data. Namely, deletion is preferentially performed from the Newest Data of the 16-th (segment) of FIG. 9 to prepare unused capacity (LIFO system). In this case, the maximum reproducible position shown in FIG. 5 is shortened. In this embodiment, as such a data deletion method, there may be employed a scheme to preferentially perform deletion from data remote from a current reproduction position in connection with both the case of reproduced data and the case of unreproduced data. In the prior art, in the streaming reproduction, when a jump to a position at which data is not yet sufficiently accumulated in the buffer is performed, user had to wait reproduction until a certain amount of data is accumulated in the buffer, and when a jump to an arbitrary position is performed, data accumulated before the jump was lost.

In this embodiment, when user designates an arbitrary position (data unreception) to perform reproduction thereof in the streaming reproduction, data having been received before the designation are continuously reproduced for a waiting time, thereby allowing user to enjoy moving images even for the waiting time during buffering by utilizing already existing data, and realizing seamless-like switching.

Although several embodiments are exemplified, there are no intention to limit the scope of the invention. These embodiments may be implemented in other forms, and may be subjected to various omissions, replacements and/or modifications/changes within the scope of the invention. These embodiments and/or modifications/changes thereof will fall within the scope of claims and their equivalents.

1. A video display apparatus, comprising:
a buffer configured to receive data;
a buffer controller configured to control the buffer; and
a reproduction part configured to reproduce the data accumulated in the buffer,
wherein, when reproduction from an arbitrary position is designated for a time during which the reproduction part reproduces the data, the buffer controller controls the buffer to accumulate data of a designated destination while continuing reproduction of the data left in the buffer.

2. The apparatus of claim 1,
wherein, when the buffer controller determines that the data of the designated destination is accumulated by a certain amount, the reproduction part performs switching to reproduction of the data from the designated destination.

3. The apparatus of claim 1,
wherein, during accumulation of the data of the designated destination into the buffer, when the buffer is full and already reproduced data is left in the buffer, the buffer controller preferentially deletes older data from the reproduced data.

4. The apparatus of claim 1,
wherein, during accumulation of the data of the designated destination into the buffer, when the buffer is full and already reproduced data is not left in the buffer, the buffer controller preferentially deletes later data from the data left in the buffer before designation of the arbitrary position.

5. A buffer management method, comprising:
receiving data by a buffer;
controlling the buffer; and
reproducing the data accumulated in the buffer,
wherein, when reproduction from an arbitrary position is designated for a time during which the data is reproduced, data of a designated destination is accumulated in the buffer while continuing reproduction of the data left in the buffer.

6. The method of claim 5,
wherein, when it is determined that the data of the designated destination is accumulated by a certain amount, switching of reproduction to the data from the designated destination is performed.

7. The method of claim 5,
wherein, during accumulation of the data of the designated destination in the buffer, when the buffer is full and already reproduced data is left in the buffer, older data is preferentially deleted from the reproduced data.

8. The method of claim 5,
wherein, during accumulation of the data of the designated destination in the buffer, when the buffer is full and already reproduced data is not left in the buffer, newer data is preferentially deleted from the data left in the buffer before designation of the arbitrary position.

9. A video display system, comprising:
a distribution server configured to distribute data;
a buffer configured to receive the data from the distribution server;
a buffer controller configured to control the buffer; and
a reproduction part configured to reproduce the data accumulated in the buffer,
wherein, when reproduction from an arbitrary position is designated for a time during which the reproduction part reproduces the data, the buffer controller controls the buffer to accumulate data of a designated destination while continuing reproduction of the data left in the buffer.
